(19) United States
(12) Patent Application Publication
(10) Pub. No.: US 2010/0269091 A1
(43) Pub. Date: Oct. 21, 2010

(54) JVM EXCEPTION DEBUGGING

(75) Inventors: James W. Barnes, Creedmoor, NC (US); Dhaval D. Patel, Cary, NC (US); Ryan R. Wilson, Rolesville, NC (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/426,605

(22) Filed: Apr. 20, 2009

(51) Int. Cl. G06F 11/36; G06F 9/44

(52) U.S. Cl. 717/106; 717/128

(57) ABSTRACT

A method for improving of runtime exception debugging by providing a custom defined and dynamically updated system property to be checked whenever unhandled condition is reached.

### FIELD OF THE INVENTION

The invention relates generally application development within a runtime computing environment and more specifically, relates to improving the error trapping mechanisms within the runtime computing environment.

### BACKGROUND OF THE INVENTION

Historically, most software has been designed under the assumption that it would never fail. Software would have little or no error detection capabilities designed into it. When a software error or failure did occur, it was usually the computer operating system that detected the error or the computer operator cancelled the execution of the software program because the program was not producing the correct results.

FIG. 1 is a schematic diagram illustrating stages commonly taken by software designers during the development/production cycle of a software product. At stage 101, the software coding occurs and includes preparing the software for execution within a runtime environment. Preparing software to be executed is well known to those skilled in the art, and may include, for example, writing source code, compiling the source code or converting the source code into an intermediary form. Runtime environments include operating systems executing on computer architectures, but are not limited to such environments. Also included are virtual environments such as the Java™ Virtual Machine (or “JVM”) (see e.g., The Java™ Virtual Machine Specification (1999)).

Thus, for example, when preparing software for execution in the Java™ programming language, a programmer will write the source code in the Java™ programming language and convert the source code into an intermediary form, called “bytecode”. The bytecode is then executed on a JVM and the JVM constitutes the runtime environment for the coded software.

After software has been prepared in coding stage 100, the software is tested in stage 101 for obvious errors, or those which are apparent to testing personnel. When an error is found, usually observed by the testing personnel while executing a specifically designed suite of test operations, a software designer takes actions to correct the errors. For example, the software product may be encoded with error handling logic to assist the software designer in locating and correcting errors within the software. The error handling logic is typically part of the software product, written and used by the software designer to locate errors in the written code. Consequently, the error handling logic includes errors the software designer foresees occurring when writing the source code, as well as those errors that occurred during testing, and hence previously unforeseen by the software designer. As an example of error handling logic, the Java™ programming language uses “exceptions” to assist the designer in handling errors. An exception in Java™ is an event (i.e., an action that triggers a corresponding response within the software; see generally Ambler, The Object Primer: Agile Model Driven Development with UML, Cambridge University Press (2004)), which occurs during the execution of a program, that disrupts the normal flow of the program's instructions. In addition, because the Java™ programming language is an object-oriented programming language, when an error occurs, an exception object is created from a corresponding exception class (see e.g., Zakhour et al., The Java™ Tutorial: A Short Course on the Basics, 4th Edition (2006)). The exception object contains information about the error, including its type and the state of the program when the error occurred. Creating an exception object within a program is commonly referred to as “throwing” an exception. Thus, by throwing an exception within the program, a designer of a software project written in the Java™ programming language is able to diagnosis and corrects errors during stage 101.

Next, at stage 102, the software enters production and remains there until an error occurs. FIG. 1 shows this relationship as a loop 102a between stages 102 and 103; stage 104 is not entered until an error is detected at stage 103. Error detection, within the context of FIG. 1 is very broad and includes, for example, when software written in the Java™ programming language throws an exception, as described above, or the software fails is some manner (sometimes catastrophically, causing the runtime environment to cease operation). Upon a software error or failure, the software determines whether the error can be handled by current error handling logic, at stage 104. As discussed above, in the Java™ programming language, error handling logic is characterized by the software's handling of exceptions generated during the execution of a program. When the error is handled by the current error handling logic, the production cycle moves to stage 105 to debug the problem. Debugging the problem may require a simple action on the part of the user (e.g. typing an incorrect password may cause the error handling logic to display the message: “password incorrect, please try again”), or it may require more complex actions—for example, debugging a problem after production, at stage 105, may involve the same steps described above during stage 102.

Otherwise, if at 104 it is determined that current error logic cannot handle the specific error presented (determined, for example, by an unexpected failure in the software or runtime environment's operation), requirements for new error handling are collected at 106 and then returned to the coding stage 100 for the developer to provision for the error. Even after all the data is collected, the cause of the program error is determined and the fix is generated and tested, another problem still faces software support personnel. If this problem occurs in another copy of the same software executing on another runtime environment (e.g., another operating system or computer architecture), the error cannot quickly be determined and resources may be wasted trying to resolve a problem that might have already been resolved. This is significant drawback of methodology shown in FIG. 1. When attempting to determine whether a software problem has already been discovered, reported, and/or fixed, software support personnel will often rely on a problem description from the person that encountered the error or failure. Different people, however, will describe the same problem with different problem symptoms, making it difficult, if not impossible, to identify an already-known problem and match it up with the existing solution. A software designer may spend several hours or days reviewing diagnostic data for a software problem only to find later that the software problem had been reported and resolved at an earlier time.

In addition to the production cycle described above, recent advances in development environments enable specialized enhancements thereto (commonly referred to as “add-ons”) from a variety of software vendors to provide additional information about the execution of the source code, which is independent of the source code and capable of providing information regarding errors of interest. For example, JVMPI is profile interface for the JVM, which allows a software designer to profile specific areas within a software project and is used, for example, as an add-on for the Eclipse Interactive Development Environment (“IDE”). JVMPI is not effective in diagnosing errors, however, if the designer does not understand where in the source code the error is occurring (i.e. a randomly occurring error) or the software project has left development (stage 101) and has entered production (stage 102) in FIG. 1. For these reasons, it would be desirable to provide run time error and exception handling of unanticipated or new errors without having to rely on add-on products.

Moreover, current methods in JVM require a full system memory dump when certain, catastrophic exceptions are encountered and often create a very large file, most of which is noise and not pertinent to the error. As a result of this impertinent data, identifying a problem for further troubleshooting and/or debugging becomes difficult. For example, in multi-threaded runtime environments (such as the JVM), multiple application server threads might fail under certain error conditions and the JVM may request a thread dump (e.g., a “TDUMP” in Java) for each of those threads. This situation may occur, for example, when The software throws an exception in which there is no error handling logic to respond to the thrown exception, i e., an unhandled exception, which causes the JVM to perform a thread dump with multiple threads active and cease operation. Consequently, a large number of thread dumps occur concurrently, which may lead to other serious problems, such as excessive consumption of storage resources and, potentially, a shortage of auxiliary storage. Although the number of thread dumps can be specified using an environment variable, the shortcoming is still present as sizes of each of such thread dumps increases.

In summary, the existing process for software error correction embraces a methodology which waits for the damage caused by a software error to surface. Then, error handling logic is implemented, the problem is recreated, and the execution path of the problem program is followed while large amounts of data are collected, hopefully catching the data that will determine what went wrong.

It would, therefore, be desirable to reduce the difficulty of such error debugging, or exception handling, by providing a custom defined and dynamically updated property within the runtime environment (i.e. a “system property”) to be checked whenever an unhandled error condition is reached.

### SUMMARY OF THE INVENTION

The present invention is a system, method and computer program product for modifying the existing process of exception handling within the runtime environment without any add-on products. More specifically, the present invention provides a method of defining specific error handling within a runtime environment and determining whether a defined error has occurred. Upon such a determination, the runtime environment performs the specific error handling as defined by the software designer.

According to one embodiment of the present invention, a method and system is disclosed that allows for a runtime environment (e.g., the Java Runtime Environment, or simply “JRE”) to respond to an unhandled error instead of monitoring the executing software (i.e. software executing within the runtime environment) for known errors only. More specifically, the troubleshooting of errors, e.g., null or un-initialized objects that may be many layers deep in the code, is provided by setting a system property to respond to errors within the runtime environment, instead of relying on error handling within the executing software.

In addition, one embodiment of the present invention allows for error handling to become adjustable at runtime. Runtime adjustment is achieved by adding a system property into a runtime environment, e.g., the JVM, that is modified at startup or changeable at runtime. A user of such a JVM, i.e., either programmer or a quality assurance specialist according to one embodiment of the present invention, is provided with an option to detect errors not handled by the executing software by enabling such a system property. Then, the user will have an option to disable the system property after enough data has been collected to troubleshoot the problem, without requiring an outage of the whole system.

Thus, in accordance with one aspect of the invention, there is provided a method for performing error tracking occurring within a calling method and executing within a runtime computing environment, said method comprising:

detecting occurrence of an error;

determining whether said error is automatically handled by error logic; and if not currently handled,

adding a system property to the runtime computing environment for tracking subsequent occurrence of said error;

enabling said system property;

tracking at least one of a list of threads and a list of objects, which are currently resident in system memory; and

creating a dump file in response to said tracking, and said tracking outputs said at least one of said list of threads and said list of objects to the dump file.

According to another one aspect of the present invention, there is provided a system for performing error tracking in a runtime computing environment, comprising:

a storage unit;

means for detecting occurrence of an error;

means for determining whether said error is automatically handled by error logic; and if not currently handled,

means for adding a system property to said runtime environment for tracking subsequent occurrence of said error;

means for enabling said system property;

means for tracking at least one of a list of threads and a list of objects, which are currently resident in system memory; and

means for creating a dump file on said storage unit in response to said means for tracking, and said means for tracking outputs said at least one of said list of threads and said list of objects to the dump file

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed descriptions of illustrative embodiments when read in conjunction with the accompanying drawings. In each of the drawings below, as well as the respective descriptions, the same numbers are used throughout to reference like components and/or features.

FIG. 1 is a schematic diagram of the existing development and production methodology.

FIG. 2 is a schematic diagram illustrating system error handling logic, according to one embodiment of the present invention.

FIG. 3 illustrates a general computer environment that can be used to implement one embodiment of present invention.

### DETAILED DESCRIPTION OF THE INVENTION

The invention is directed to a method for customizing error trapping and error handling in a runtime environment such as provided by a virtual machine (e.g., the JVM). More specifically, the system and method of the invention provides for the adding of an adjustable system property to the existing runtime environment, and thereafter determining, when an error has occurred, whether the system property is enabled to respond to the error.

FIG. 2 is a schematic diagram illustrating system error handling logic, according to one embodiment of the present invention. For simplicity in the discussion below only, and not meant to be interpreted as a limitation, the description below will be described according to one embodiment of the present invention written in the Java™ programming language and executed within a JVM. Those skilled in the art would understand that the invention, as described below according to the exemplary embodiment, is not limited to the Java™ programming language or the JRE, other environments and programming languages, e.g., C++, etc.

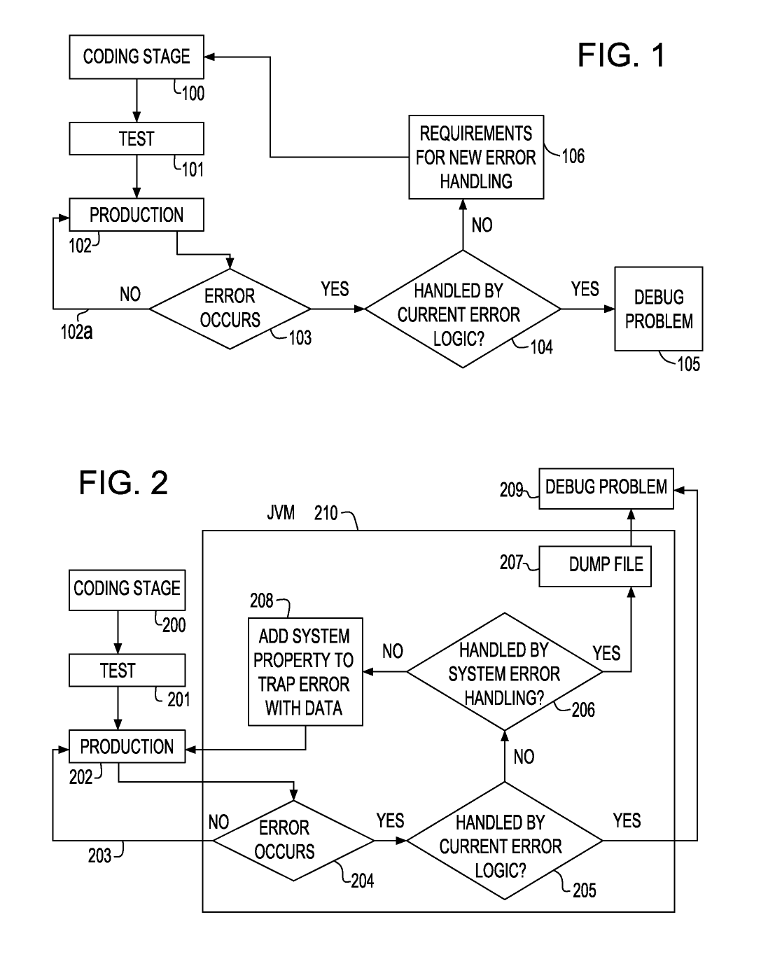

In FIG. 2, coding is performed as stage 200, testing is performed at stage 201, in a manner possibly similar to the description of stage 100 and 101 in FIG. 1. Production occurs at stage 202 (e.g., the Java™ program, as coded in stage 200, is deployed and run on a JVM by an end-user) until an error occurs at stage 204, as indicated by loop 203.

Illustrated within JVM 210, are the operations performed by the JVM in accordance with one embodiment of the present invention. At stage 205, in response to determination of an error at step 204, the JVM determines whether the error is handled by the current error logic written for the Java™ program, which is currently being executed and written, in one embodiment, during coding stage (stage 200) or while being tested (stage 201). Stated another way, the JVM determines in stage 205 whether the Java™ program being executed was coded to address the exception that has been thrown. If the current error logic was written in anticipation of the error (i.e., the code addresses the exception), the error is debugged at stage 209, in a manner possibly similar to the methods described in relation to FIG. 1.

At step 205, however, if the error is not handled by the program currently being executed (i.e., the Java™ program does not address the thrown exception) the JVM next determines whether the error is handled by system error handling at stage 206. In particular, during stage 206, the JVM determines whether a system property was enabled that responds to the exception being thrown by the Java™ program being executed. In one embodiment, enabling the system property is performed either as an argument passed to the JVM upon initiating the runtime environment (hence, the system property is automatically enabled without further input from the user). In an alternative embodiment, the system property may be enabled programmatically—for example pressing a button via a user interface that will cause the Java™ program to execute the “System.setProperty( )” method to set the specified property within the currently running JVM (hence, the system property is manually enabled by a user).

By enabling the system property for the JVM, code within the Java™ exception class will be enabled to provide default actions whenever the Java™ program throws the same exception. For example, the following pseudo code illustrates how the constructor for the java.lang.throwable class determines whether a system property of the current running JVM was enabled and how to handle the exception when thrown:

```
if (system.property != null)
{
  if system property == throwable.type)
  {
    Gather additional information (e.g., enable the JVM to perform a
    thread dump to list the threads resident in memory and/or generate
    a list of objects that the method throwing the exception was using)
  }
}
```

As a result of the pseudo code above, every time an exception class is created (i.e., an exception is thrown), the above constructor for the java.lang.throwable class is automatically executed, due to class inheritance and object initiation (both common features of object-oriented programming languages and the Java™ programming language). Thus, at stage 206, the JVM determines whether a system property has been set to handle the exception currently being thrown. When such a system property has been enabled, the error is processed according to the error handling code in the JVM; for example, outputting to a dump file as shown in stage 207. Subsequently, the error is debugged at stage 209, in a manner that possibly similar to the methods described in relation to FIG. 1.

When a system property has not been enabled within the JVM to handle the thrown exception, a system property is added at stage 208 to trap (or respond) to the exception, to allow the JVM to address that the exception in the future by enabling the added system property.

In one exemplary embodiment, not shown in FIG. 2, adding a system property includes adding new code to java.lang.throwable constructor, as described above, and making sure the new java.lang.throwable is available to the JVM. This process includes, for example, compiling the class into a Java™ archive file (or “JAR” file) and adding the JAR filename to the “classpath” environment variable when running the JVM. Then, as described above, the system property can be enabled manually or automatically. Consequently, after the new system property has been added in stage 208, the JVM is now capable of handling what was previously an unhandled exception in production (stage 202), without resorting to the coding stage (stage 200).

By avoiding stage 200 when resolving an unhandled exception, a software designer is able to quickly diagnosis and resolve any errors (random or otherwise) without modifying the source code of the program; instead, the software designer allows the runtime environment to enable custom error handling logic (e.g. trapping exceptions in the Java™ programming language) that provides useful information to address the source of the error.

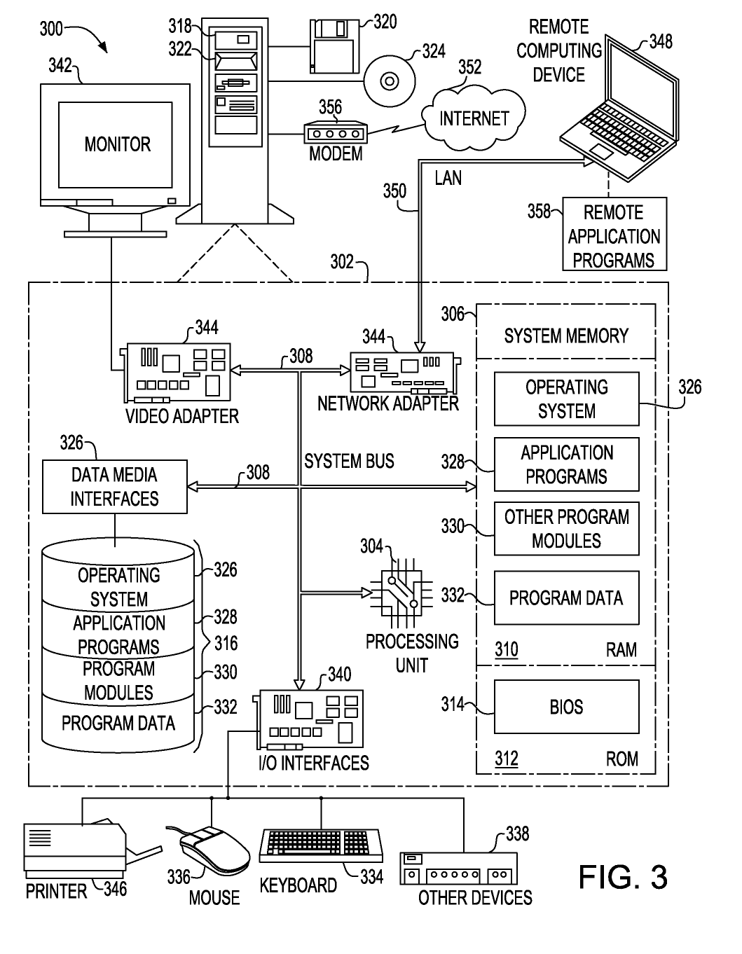

FIG. 3 illustrates a general computer environment 300 that can be used to implement one embodiment of present invention, as described herein. The computer environment 300 is only one example of a computing environment and is not intended to suggest any limitation as to the scope of use or functionality of the computer and network architectures. Neither should the computer environment 300 be interpreted as having any dependency or requirement relating to any one or combination of components illustrated in the exemplary computer environment 300.

Computer environment 300 includes a general-purpose computing device in the form of a computer 302. The components of computer 302 can include, but are not limited to, one or more processors or processing units 304, a system memory 306, and a system bus 308 that couples various system components including the processor 304 to the system memory 306.

The system bus 308 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 302 typically includes a variety of computer readable media. Such media can be any available media that is accessible by computer 302 and includes both volatile and non-volatile media, removable and non-removable media.

The system memory 306 includes computer readable media in the form of volatile memory, such as random access memory (RAM) 310, and/or non-volatile memory, such as read only memory (ROM) 312. A basic input/output system (BIOS) 314, containing the basic routines that help to transfer information between elements within computer 302, such as during start-up, is stored in ROM 312. RAM 310 typically contains data and/or program modules that are immediately accessible to and/or presently operated on by the processing unit 304.

Computer 302 may also include other removable/non-removable, volatile/non-volatile computer storage media. By way of example, FIG. 3 illustrates a hard disk drive 316 for reading from and writing to a non-removable, non-volatile magnetic media (not shown), a magnetic disk drive 318 for reading from and writing to a removable, non-volatile magnetic disk 320 (e.g., a “floppy disk”), and an optical disk drive 322 for reading from and/or writing to a removable, non-volatile optical disk 324 such as a CD-ROM, DVD-ROM, or other optical media. The hard disk drive 316, magnetic disk drive 318, and optical disk drive 322 are each connected to the system bus 308 by one or more data media interfaces 326. Alternatively, the hard disk drive 316, magnetic disk drive 318, and optical disk drive 322 can be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, a removable magnetic disk 320, and a removable optical disk 324, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 316, magnetic disk 320, optical disk 324, ROM 312, and/or RAM 310, including by way of example, an operating system 326, one or more application programs 328, other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as a keyboard 334 and a pointing device 336 (e.g., a “mouse”). Other input devices 338 (not shown specifically) may include a microphone, joystick, game pad, satellite dish, serial port, scanner, and/or the like. These and other input devices are connected to the processing unit 304 via input/output interfaces 340 that are coupled to the system bus 308, but may be connected by other interface and bus structures, such as a parallel port, game port, or a universal serial bus (USB).

A monitor 342 or other type of display device can also be connected to the system bus 308 via an interface, such as a video adapter 344. In addition to the monitor 342, other output peripheral devices can include components such as speakers (not shown) and a printer 346 which can be connected to computer 302 via the input/output interfaces 340.

Computer 302 can operate in a networked environment using logical connections to one or more remote computers, such as a remote computing device 348. By way of example, the remote computing device 348 can be a personal computer, portable computer, a server, a router, a network computer, a peer device or other common network node, and the like. The remote computing device 348 is illustrated as a portable computer that can include many or all of the elements and features described herein relative to computer 302.

Logical connections between computer 302 and the remote computer 348 are depicted as a local area network (LAN) 350 and a general wide area network (WAN) 352. Both the LAN and WAN form logical connections via wired communication mediums and appropriate communication protocols (such as Ethernet, see e.g., IEEE 802.3-1998 Std) or wireless communication mediums and appropriate communications protocols (such as Wi-Fi, see e.g., IEEE 802.11-2007 Std). Such networking environments are commonplace in homes, offices, enterprise-wide computer networks, intranets, and the Internet.

When implemented in a LAN networking environment, the computer 302 is connected to a local network 350 via a network interface or adapter 354. When implemented in a WAN networking environment, the computer 302 typically includes a modem 356 or other means for establishing communications over the wide network 352. The modem 356, which can be internal or external to computer 302, can be connected to the system bus 308 via the input/output interfaces 340 or other appropriate mechanisms. It is to be appreciated that the illustrated network connections are exemplary and that other means of establishing communication link(s) between the computers 302 and 348 can be employed.

In a networked environment, such as that illustrated with computing environment 300, program modules depicted relative to the computer 302, or portions thereof, may be stored in a remote memory storage device. By way of example, remote application programs 358 reside on a memory device of remote computer 348. For purposes of illustration, application programs and other executable program components such as the operating system are illustrated herein as discrete blocks, although it is recognized that such programs and components reside at various times in different storage components of the computing device 302, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above are also included within the scope of computer readable media.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed as new:

1. A method for performing error tracking occurring within a calling method and executing within a runtime computing environment, said method comprising:
detecting occurrence of an error;
determining whether said error is automatically handled by error logic; and if not currently handled,
adding a system property to the runtime computing environment for tracking subsequent occurrence of said error;
enabling said system property;
tracking at least one of a list of threads and a list of objects, which are currently resident in system memory; and
creating a dump file in response to said tracking, and said tracking outputs said at least one of said list of threads and said list of objects to the dump file.

2. The method according to claim 1, wherein the runtime computing environment outputs to the dump file without causing a system shutdown.

3. The method according to claim 1, wherein the list of objects includes objects used by the calling method.

4. The method according claim 1, wherein the system property is enabled or modified at runtime by a user.

5. The method according to claim 4, wherein the system property is disabled by the user upon required data being collected.

6. The method according to claim 1, wherein the runtime environment is Java Virtual Machine, said adding a system property includes:
accessing a constructor to a class written in the Java programming language; and
adding new code to handle said error to said constructor to correct said error.

7. The method according to claim 1, where the dump file is created on a file system where the unhandled condition occurred.

8. The method according to claim 1, wherein the dump file is compressed.

9. A system for performing error tracking in a runtime computing environment, comprising:
a storage unit;
means for detecting occurrence of an error;
means for determining whether said error is automatically handled by error logic; and if not currently handled,
means for adding a system property to said runtime environment for tracking subsequent occurrence of said error;
means for enabling said system property;
means for tracking at least one of a list of threads and a list of objects, which are currently resident in system memory; and
means for creating a dump file on said storage unit in response to said means for tracking, and said means for tracking outputs said at least one of said list of threads and said list of objects to the dump file.

10. The system according to claim 9, wherein the runtime computing environment outputs to the dump file without causing a system shutdown.

11. The system according to claim 9, wherein the list of objects includes objects used by the calling method.

12. The system according claim 9, wherein the system property is enabled or modified at runtime by a user.

13. The system according to claim 12, wherein the system property is disabled by the user upon required data being collected.

14. The system according to claim 9, wherein the runtime environment is Java Virtual Machine, said means for adding a system property includes:
accessing a constructor to a class written in the Java programming language; and
adding new code to handle said error to said constructor to correct said error.

15. The system according to claim 9, where the dump file is created on the file system where the unhandled condition occurred.

16. The system according to claim 9, wherein the dump file is compressed.
